(19) United States
(12) Patent Application Publication
(10) Pub. No.: US 2013/0014630 A1
(43) Pub. Date: Jan. 17, 2013

(54) Stringed Musical Instrument

(71) Applicant: Jiyoung Um, La Mirada, CA (US)

(72) Inventor: Jiyoung Um, La Mirada, CA (US)

(21) Appl. No.: 13/182,437

(22) Filed: Jul. 13, 2011

(51) Int. Cl. G10D 3/02

(52) U.S. Cl. 84/294

(57) ABSTRACT

A stringed musical instrument that includes strings, each of which is adapted to create vibration of pre-determined range of frequency, a main body that amplifies the vibration created by the strings and a string support device that supports the strings and is connected to the main body. The strings are supported by a string tension adjust device around one end of the instrument. The strings are supported by a support piece that supports all of the strings together and is fixed to the main body around the other end of the instrument. A vibration medium is placed between the support piece and the main body. The frequency range for the vibration medium is substantially similar to the pre-determined range of frequency for the strings.

### BACKGROUND OF THE INVENTION

1. Field of the invention

The invention is related to a stringed musical instrument. More particularly, the present invention is related to a support structure for a stringed musical instrument, which holds and supports strings of the instrument to the body of the instrument.

2. Description of the Prior Art

A string musical instrument generally comprises strings, a hollow body that amplifies vibration of strings, and string support and adjusting device that supports strings and adjusts tension of the strings. A violin, a representative stringed instrument, comprises four strings, a body, a bridge, tuning pegs, a tail piece, a tailgut and an end pin. The strings are fixed between the tail piece and the tuning pegs and supported by the bridge in between. Every part of a violin affects the sound that the violin produces. For example, the bridge is a component that transmits the vibration of the strings to the body. The bridge acts a mechanical acoustic filter and has a prominent effect on the sound. Various development has been made for the material, shape and flex of a bridge to improve the sound of the instrument. Since the quality of sound produced by a musical instrument is highly subjective and extremely hard to evaluate, improvements for parts other than major sound generating and transmitting such as the strings, bridge and body, have not been diversely tried.

### SUMMARY OF THE INVENTION

An objective of the invention is to provide a stringed musical instrument that has efficient vibration generation and transmission mechanism.

In order to achieve the objective, the present invention provides a stringed musical instrument that includes one or more strings, each of which is adapted to create vibration of pre-determined range of frequency, a main body that amplifies the vibration created by the strings and a string support device that supports the strings and is connected to the main body. The main body comprises a first end and a second end. The strings are supported between the first end and the second end. The string support device comprises a string tension adjust device positioned near the first end. The strings are supported by the string tension adjust device around the first end. The string tension adjust device comprises one or more string adjusting units, the number of which corresponds to the number of the strings. The string tension adjust device is firmly fixed to the main body.

The string support device further comprises a support piece that supports all of the strings together and is fixed to the main body around the second end, and a vibration medium that is placed between the support piece and the main body. The vibration medium is adapted to create vibration of pre-determined range of frequency.

The pre-determined range of frequency for the vibration medium is substantially similar to the pre-determined range of frequency for the strings.

Preferably, the vibration medium comprises a string segment. The string segment comprises a core and wounding that winds the core. Preferably, the core is made of synthetic fiber, and the wounding is made of metal.

Preferably, the pre-determined range of frequency for the vibration medium is substantially similar to the pre-determined range of frequency for one of the strings. More preferably, the pre-determined range of frequency for the vibration medium is substantially similar to the pre-determined range of frequency for the string that has the lowest pre-determined range of frequency among the strings. The the string segment of the vibration medium may be made of the string that has the lowest pre-determined range of frequency.

Preferably, the string support device further comprises a support boss that is attached to the second end of the main body. The support piece comprises a support piece plate and a wire bracket that is connected to the support piece plate at one end and is fixed by the support boss at the other end. The vibration medium is placed between the wire bracket and the main body.

Preferably, the main body comprises a top plate, a back plate, and a rib that connects the top plate and the back plate, and the vibration medium is placed on the back plate near the rib.

The the main body may further comprise a saddle plate. The saddle plate contacts part of the top plate around the second end and the saddle plate is harder than the top plate. The vibration medium is placed between the saddle plate and the wire bracket.

The advantageous effects of the present invention are: (1) the sound produced by the instrument is more intense and has better timbre; (2) improvement of sound is achieved with minor addition because the vibration medium is placed at a position where the strings are fixedly supported by the body; (3) improvement of sound is better targeted because the vibration medium adopts the string for the instrument.

### BRIEF DESCRIPTION OF THE DRAWINGS

The accompanying drawings illustrate the best embodiments of the present invention. In the drawings:

FIG. 1 is a front elevation view showing a stringed musical instrument of the present invention;

FIG. 2 is a side elevation view showing the instrument;

FIG. 3 is a front elevation view showing a support piece and a vibration medium;

FIG. 4 is a side elevation view showing the support piece and the vibration medium;

FIG. 5 is a perspective view of a string segment; and

FIG. 6 is a cross-sectional view taken along line VI-VI in FIG. 5.

### DESCRIPTION OF PREFERRED EMBODIMENTS

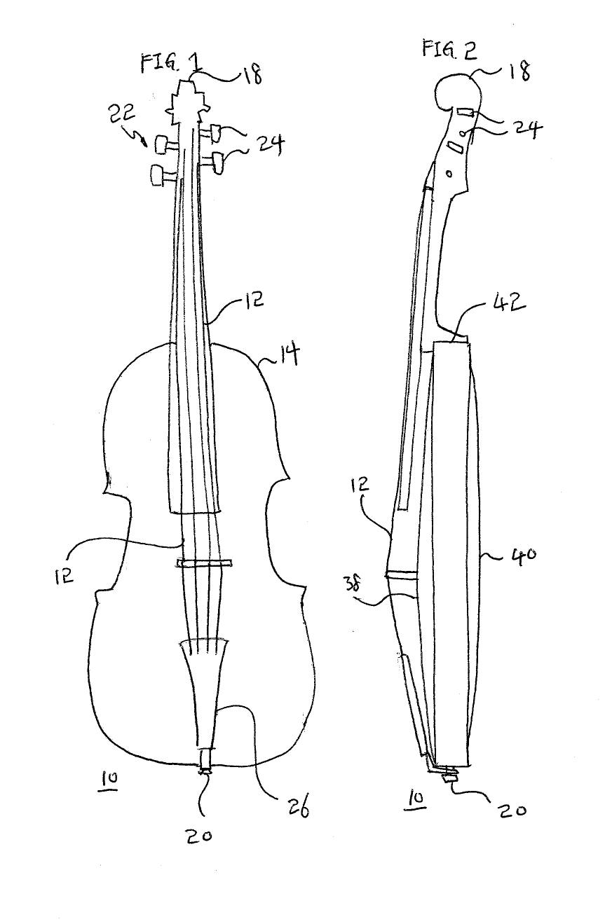

FIGS. 1 and 2 show a stringed musical instrument 10 that includes one or more strings 12, each of which is adapted to create vibration of pre-determined range of frequency, a main body 14 that amplifies the vibration created by the strings 12 and a string support device 16 that supports the strings 12 and is connected to the main body 14. The main body 14 comprises a first end 18 and a second end 20. The strings 12 are supported between the first end 18 and the second end 20. The string support device 16 comprises a string tension adjust device 22 positioned near the first end 18. The strings 12 are supported by the string tension adjust device 22 around the first end 18. The string tension adjust device 22 comprises one or more string adjusting units 24, the number of which corresponds to the number of the strings 12. The string tension adjust device 22 is firmly fixed to the main body 14.

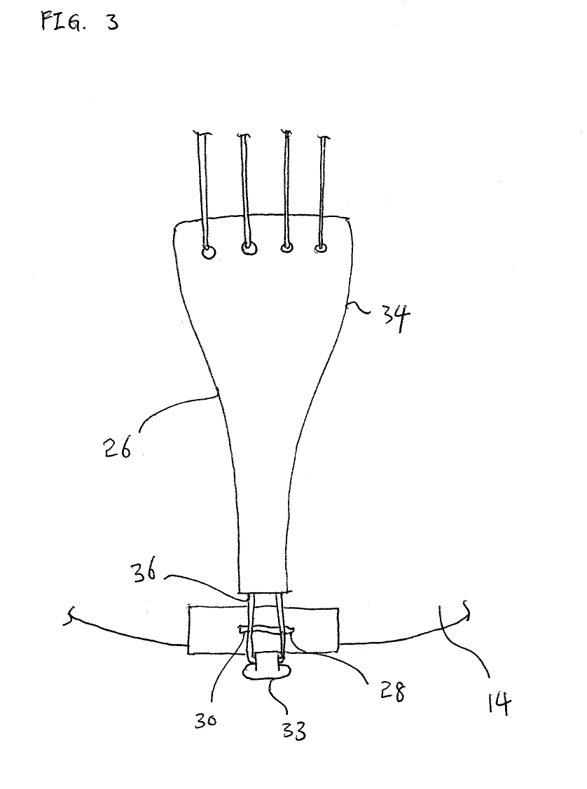

FIGS. 3 and 4 show that the string support device 16 further comprises a support piece 26 that supports all of the strings 12 together and is fixed to the main body 14 around the second end 20, and a vibration medium 28 that is placed between the support piece 26 and the main body 14. The vibration medium 28 is adapted to create vibration of pre-determined range of frequency.

The pre-determined range of frequency for the vibration medium 28 is substantially similar to the pre-determined range of frequency for the strings 12.

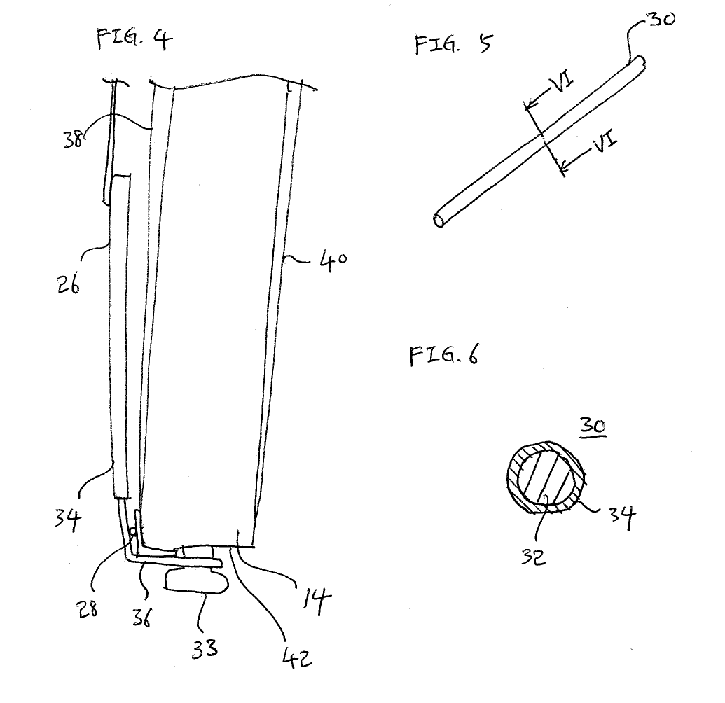

FIGS. 5 and 6 show that the vibration medium 28 comprises a string segment 30. The string segment 30 comprises a core 32 and wounding 34 that winds the core 32. Preferably, the core 32 is made of synthetic fiber, and the wounding 34 is made of metal. An example of the metal is silver.

Preferably, the pre-determined range of frequency for the vibration medium 28 is narrowed down so that the range is substantially similar to the pre-determined range of frequency for one of the strings 12. More preferably, the pre-determined range of frequency for the vibration medium 28 is substantially similar to the pre-determined range of frequency for the string 12 that has the lowest pre-determined range of frequency among the strings 12. The the string segment 30 of the vibration medium 28 may be made of the string 12 that has the lowest pre-determined range of frequency.

Preferably, the string support device 16 further comprises a support boss 33 that is attached to the second end of 20 of the main body 14. The support piece 26 comprises a support piece plate 34 and a wire bracket 36 that is connected to the support piece plate 34 at one end and is fixed by the support boss 33 at the other end. The vibration medium 28 is placed between the wire bracket 36 and the main body 14.

Referring back to FIG. 2, the main body 14 comprises a top plate 38, a back plate 40, and a rib 42 that connects the top plate 38 and the back plate 40, and the vibration medium 28 is placed on the back plate 40 near the rib 42.

The the main body 14 may further comprise a saddle plate 44. The saddle plate 44 contacts part of the top plate 38 around the second end 20 and the saddle plate 44 is harder than the top plate 38. The vibration medium 28 is placed between the saddle plate 44 and the wire bracket 36. Specifically, the string segment 30 is squeezed between them.

This embodiment shows a violin. The string tension adjust units 24, the support boss 33, the support piece plate 34 and the wire bracket 36 correspond to the pegs, the end button, the tail piece, and the tail gut of a violin. For a violin, the strings are firmly fixed to the corpus through the neck. On the other hand, strings are supported in suspended state through the tail piece. Vibration of the strings are transmitted through very narrow and small physical area. The tail gut can influence the vibration of the strings, and in turn the sound of the violin significantly because the tail gut is a pivoting point for all of the strings and support by the tail piece and the tail gut is not that rigid as the support by the pegs. The tail gut is supported by the end button at its end, and also contacts the corpus, usually via the saddle. The present invention utilizes this narrow yet dynamic physical contact point, that is, the string segment of the vibration medium is squeezed between the tail gut and the saddle. Also a part or musical component that has vibration characteristic similar to the sound of the violin, specifically a segment of G string is used for the vibration medium.

The invention covers all stringed musical instruments to which the structure described in the claims can be applied.

1. A stringed musical instrument comprising:
a) one or more strings, each of which is adapted to create vibration of pre-determined range of frequency;
b) a main body that amplifies the vibration created by the strings; and
c) a string support device that supports the strings, wherein the string support device is connected to the main body;
wherein the main body comprises a first end and a second end, wherein the strings are supported between the first end and the second end, wherein the string support device comprises a string tension adjust device positioned near the first end, wherein the strings are supported by the string tension adjust device around the first end, wherein the string tension adjust device comprises one or more string adjusting units, the number of which corresponds to the number of the strings; wherein the string tension adjust device is firmly fixed to the main body;
wherein the string support device further comprises a support piece that supports all of the strings together and is fixed to the main body around the second end, and a vibration medium that is placed between the support piece and the main body, wherein the vibration medium is adapted to create vibration of pre-determined range of frequency.

2. The stringed musical instrument of claim 1, wherein the pre-determined range of frequency for the vibration medium is substantially similar to the pre-determined range of frequency for the strings.

3. The stringed musical instrument of claim 2, wherein the vibration medium comprises a string segment.

4. The stringed musical instrument of claim 3, wherein the string segment comprises a core and wounding that winds the core.

5. The stringed musical instrument of claim 4, wherein the core is made of synthetic fiber.

6. The stringed musical instrument of claim 4, wherein the wounding is made of metal.

7. The stringed musical instrument of claim 3, wherein the pre-determined range of frequency for the vibration medium is substantially similar to the pre-determined range of frequency for one of the strings.

8. The stringed musical instrument of claim 7, wherein the pre-determined range of frequency for the vibration medium is substantially similar to the pre-determined range of frequency for the string that has the lowest pre-determined range of frequency among the strings.

9. The stringed musical instrument of claim 8, wherein the string segment of the vibration medium is made of the string that has the lowest pre-determined range of frequency.

10. The stringed musical instrument of claim 2, wherein the string support device further comprises a support boss that is attached to the second end of the main body, wherein the support piece comprises a support piece plate and a wire bracket that is connected to the support piece plate at one end and is fixed by the support boss at the other end, wherein the vibration medium is placed between the wire bracket and the main body.

11. The stringed musical instrument of claim 10, wherein the main body comprises a top plate, a back plate, and a rib that connects the top plate and the back plate, wherein the vibration medium is placed on the back plate near the rib.

12. The stringed musical instrument of claim 11, wherein the main body further comprises a saddle plate, wherein the saddle plate contacts part of the top plate around the second end, where in the saddle plate is harder than the top plate, wherein the vibration medium is placed between the saddle plate and the wire bracket.

13. The stringed musical instrument of claim 12, wherein the vibration medium comprises a string segment, wherein the string segment comprises a core and wounding that winds the core, wherein the core is made of synthetic fiber, the wounding is made of metal.

14. The stringed musical instrument of claim 12, wherein the pre-determined range of frequency for the vibration medium is substantially similar to the pre-determined range of frequency for one of the strings.

15. The stringed musical instrument of claim 14, wherein the pre-determined range of frequency for the vibration medium is substantially similar to the pre-determined range of frequency for the string that has the lowest pre-determined range of frequency among the strings.

16. The stringed musical instrument of claim 15, wherein the string segment of the vibration medium is made of the string that has the lowest pre-determined range of frequency.
